(19) United States
(12) Patent Application Publication
(10) Pub. No.: US 2004/0085970 A1
(43) Pub. Date: May 6, 2004

(54) System and method for accessing wireless internet

(75) Inventor: Eun-jin Kang, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/414,206

(22) Filed: Apr. 16, 2003

(30) Foreign Application Priority Data
Nov. 4, 2002 (KR) 2002-67857

(51) Int. Cl. H04L 12/56

(52) U.S. Cl. 370/400; 370/392

(57) ABSTRACT

A wireless Internet accessing system allowing determination and/or access to a web page by entering a telephone number of the web page holder in lieu of entering a URL of the web page. For example, the system can have a receiver receiving information from a cellular phone, a wireless Internet accessing unit wirelessly accessing an Internet, a web page address database storing telephone numbers and web page addresses of the respective telephone numbers, and a network access controller. The controller determines whether the received information has both telephone number signals and an identification key signal distinguished from the telephone number signal, retrieves a web page address corresponding to the telephone number from the web page address database, if determined that the identification key signal is additionally included, and controls the cellular phone to be wirelessly connected to the retrieved web page address through the wireless Internet accessing unit.

### CROSS-REFERENCE TO RELATED APPLICATIONS

This application claims the benefit of Korean Patent Application No. 2002-67857, filed Nov. 4, 2002, with the Korean Intellectual Property Office, the disclosure of which is incorporated herein by reference.

### BACKGROUND OF THE INVENTION

1. Field of the Invention

The present invention relates to a system and a method of wirelessly accessing the Internet (the wireless Internet), and more particularly, to a system and a method of accessing the wireless Internet allowing access to web pages on the wireless Internet through a portable and/or mobile phone, such as a cellular phone, by entering a telephone number in lieu of a URL (Uniform Resource Locator) using the portable phone.

2. Description of the Related Art

Recently, wireless Internet systems providing Internet services through portable and/or mobile phones have been developed and used in an extensive manner. For the sake of convenience, portable and/or mobile phones will herein be referred to as “cellular phones.” The wireless Internet system generally refers to a system providing wireless Internet services via terminals providing mobile telecommunication, such as the cellular phones. In particular, the wireless Internet system wirelessly provides documents written in markup languages, such as WML (Wireless Markup Language), HDML (Handheld Device Markup Language), mHTML (multilingual Hypertext Markup Language), cHTML (compact Hypertext Markup Language), to the cellular phones through wireless Internet protocols, such as WAP (Wireless Application Protocol), ME (Mobile Explorer), etc.

If a user desires to access a web page through the wireless Internet, the user is allowed to access the desired web page by entering an address of the desired web page using the cellular phone and selecting an Internet access function. Herein, the address of the web page on the wireless Internet as entered by the user has the same form as an Internet URL used when an ordinary (e.g., wire) access to a web server is made through a personal computer web browser. For example, an Internet URL address can be “http://www.samsung.com.”

However, buttons mounted on a cellular phone, employed for inputting the Internet address, are a telephone keypad used to input telephone numbers, which is not appropriate for entering a long word, such as the typical Internet URLs. In addition, for example, in case of non-English language cellular phones, to enter an English language URL, an English mode for entering the English Internet URL on the phone is needed. Therefore, to access an Internet URL in a language different than a default language of a cellular phone, the cellular phone needs an operation to provide/modify an input mode into a target language mode for entering target language characters, such as English characters (so called “English mode”), thereby making it further inconvenient to enter web page addresses.

In an attempt to solve these problems, there has been introduced a technology in which for the address of any web page the user desires to access, numerals corresponding to the address or a representative telephone number of the web page holder, are entered into the cellular phone in advance, and thereby, the user can later easily access the desired web page merely by entering the previously entered numerals or the representative telephone numbers, instead of the URL of the desired web page.

However, this related art, is like a speed dial function and requires troublesome/time consuming operations by requiring the user to enter beforehand a URL and any numerals or representative telephone number to be used in lieu of the URL, and maintain the speed dial information. Further, if the user does not know the address of a desired web page, it is not possible to enter the URL into the user's cellular phone in advance. Accordingly, using the cellular phone keypad to enter Internet URLs can be substantially inefficient and susceptible to errors, thereby frustrating real-time targeted wireless Interest access.

### SUMMARY OF THE INVENTION

Accordingly, the present invention provides a system and a method of accessing a wireless Internet where an access to any web page on the wireless Internet is available through a cellular phone by entering the telephone number of the web page holder in lieu of the URL of the web page.

Additional aspects and advantages of the invention will be set forth in part in the description which follows and, in part, will be obvious from the description, or may be learned by practice of the invention.

The present invention can be achieved by providing a wireless Internet accessing system comprising a transmitted information receiver receiving information transmitted (input) from a user's cellular phone; a wireless Internet accessing unit wirelessly accessing an Internet; a web page address database storing therein a plurality of telephone numbers and web page addresses corresponding to the respective telephone numbers; and a network access controller determining whether the transmitted information received through the transmitted information receiver includes both signals of an input telephone number and an identification key distinguished from a telephone number signal, retrieving the web page address corresponding to the input telephone number from the web page address database, if determined that the identification key signal is additionally included in the transmitted information, and then controlling the user's cellular phone to connect to the web page having the retrieved web page address, by allowing the user's cellular phone to wirelessly access the Internet through the wireless Internet accessing unit.

According to an aspect of the present invention, the wireless Internet accessing system further comprises a mobile telecommunication network accessing unit accessing a mobile telecommunication network; wherein the network access controller controls the user's cellular phone to be connected to another telephone having the input telephone number by allowing the user's cellular phone to be connected to the mobile telecommunication network through the mobile telecommunication network access unit, if determined that the transmitted information does not include the identification key signal.

The present invention may be also achieved by providing a wireless Internet accessing method comprising receiving information transmitted (input) from a user's cellular phone; determining whether the transmitted information as received includes a signal for an input telephone number and a signal for an identification key distinguished from a telephone number signal; retrieving a web page address corresponding to the input telephone number, if determined that the identification key signal is included in the transmitted information; and connecting the user's cellular phone to a web page corresponding to the retrieved web page address.

According to an aspect of the present invention, the wireless Internet accessing method further comprises allowing the user's cellular phone to be connected to a telephone having a telephone number corresponding to the input telephone number included in the transmitted information, if determined that the transmitted information does not include the identification key signal.

### BRIEF DESCRIPTION OF THE DRAWINGS

The above and/or other advantages of the present invention will become apparent and more readily appreciated from the following description of the embodiments, taken in conjunction with the accompany drawings of which:

FIG. 1 is a network configuration diagram showing an application of a wireless Internet accessing system, according to an embodiment of the present invention;

FIG. 2 is a control block diagram of the wireless Internet accessing system shown in FIG. 1, according to an embodiment of the present invention; and

FIG. 3 is a flow chart of a wireless Internet accessing method using the wireless Internet accessing system shown in FIG. 2, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

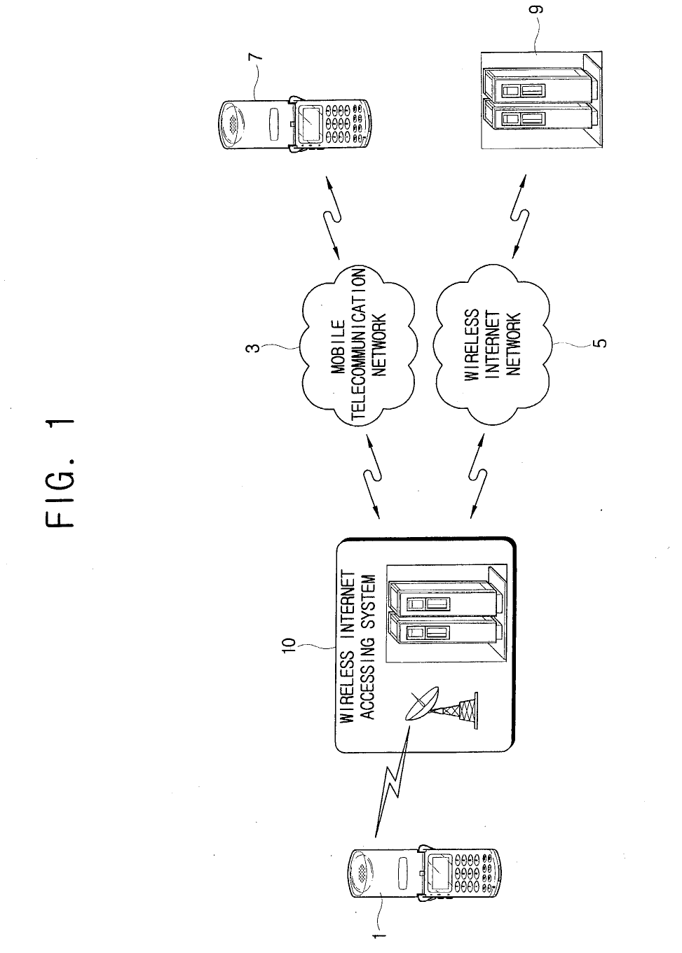

FIG. 1 is a network configuration diagram showing an application of a wireless Internet accessing system according to an embodiment of the present invention. As shown therein, the present invention comprises a cellular phone 1 allowing a user to wirelessly access the Internet, and a wireless Internet accessing system 10 deciding whether a wireless access to the Internet has been selected after receiving information comprising a telephone number transmitted (input) from the user's cellular phone 1, and then wirelessly connecting the user's cellular phone 1 to a telephone 7 holding/assigned the entered telephone number or otherwise wirelessly connecting the user's cellular phone 1 to a server 9 for the web page holding/assigned the entered telephone number.

According to the present invention, the user's cellular phone 1 is not only available for a conversation by telephone with another person through a mobile telecommunication network 3 but also for dynamically determining/locating and/or accessing a desired web page corresponding to any telephone number holder through a wireless Internet network 5. Herein, a web page can be written in markup languages, such as WML, HDML, mHTML, etc. and wirelessly provided to the user's cellular phone 1 through the wireless Internet network 5. Telephonically accessed web pages can generally be referred to as “phone pages.”

If the user desires to access, including determining, a web page using the user's cellular phone 1, the user enters a telephone number of the holder/assignee/operator of the desired web page and selects an identification key distinguished from an input of the telephone number, to thereby access the desired web page. The identification key (signal) selecting/commanding an access to the wireless Internet can comprise special (non-numeric) telephone keypad keys, such as the “#” key and the “*” key, etc., or any other input units, such as an Internet-accessible key provided in the cellular phone.

The wireless Internet accessing system 10 receives information including telephone number information transmitted (input) from the user's cellular phone 1 and wirelessly connects the user's cellular phone 1 to another phone, such as phone 7, or otherwise to the web page server 9 storing therein web pages, depending on the information received from the cellular phone 1. If only an input telephone number is included in the transmitted information from the cellular phones, the wireless Internet accessing system 10 allows the user's cellular phone 1 to be wirelessly connected to a phone, such as the phone 7 holding/assigned the input telephone number. Subsequently, the user can make a conversation by phone with the holder of the input telephone number. On the other hand, if an input telephone number and an input identification key distinguished from the input telephone number is included in the transmitted information from the cellular phone 1, the wireless Internet accessing system 10 allows the user's cellular phone 1 to be wirelessly connected to the web page server 9, thereby allowing the user's cellular phone 1 to wirelessly access a web page having a holder/assignee/operator corresponding to the input telephone number, through the wireless Internet network 5.

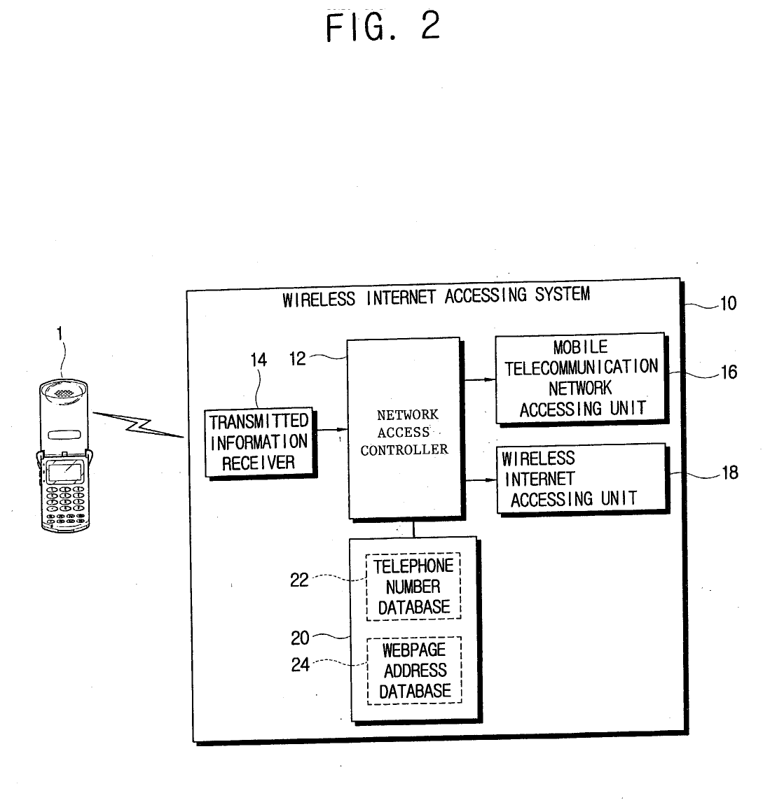

These and/or other functions of the wireless Internet accessing system 10 will be described in detail with reference to FIG. 2, which is a control block diagram of the wireless Internet accessing system 10 according to an embodiment of the present invention. As shown in FIG. 2, the wireless Internet accessing system 10 comprises a transmitted information receiver 14 receiving information transmitted (input) from the user's cellular phone 1, a mobile telecommunication network accessing unit 16 allowing the user's cellular phone 1 to be wirelessly connected to another phone 7 for establishing a telephone call, a wireless Internet accessing unit 18 allowing the user's cellular phone 1 to be wirelessly connected to the web page server 9 to wirelessly access a web page, a database 20 storing therein telephone numbers and addresses of web pages corresponding thereto, and a network access controller 12 allowing the user to verbally (orally) communicate with another telephone through the mobile telecommunication network accessing connector 16 or otherwise wirelessly access a web page through the wireless Internet accessing connector 18, based on the transmitted information from the cellular phone 1 as received through the transmitted information receiver 14.

The transmitted information receiver 14 receives information transmitted from the user's cellular phone 1. Such information transmitted from the cellular phone 1, typically comprises signals representing/interpreted by the wireless Internet accessing system 10 as numbers, characters, commands, etc. For example, the user can enter the number of another telephone 7 and/or other telephones into the user's cellular phone 1 so as to make a phone call or enter a phone page/web page number to otherwise access a web page with the user's cellular phone 1. If the user desires to make a phone call to another telephone, the transmitted information receiver 14 receives a signal corresponding to the number of the other telephone, such as cellular telephone 7 input through the user's cellular phone 1. If the user desires to access a certain web page, the transmitted information receiver 14 receives both a signal corresponding to the telephone number of the holder of the concerned web page as input through the user's cellular phone 1 and a signal corresponding to the identification key input and distinguished from the telephone number input. The input identification key or keys distinguished from the input telephone number can be special keys, such as the “#” key and “*” key, or an Internet-accessible key provided in the cellular phone 1. The transmitted information receiver 14 receives the information transmitted from the user's cellular phone 1 and supplies the received (transmitted) information to the network access controller 12.

The database 20, according to an embodiment of the present invention, comprises a telephone number database 22 and a web page address database 24, thereby providing a web page phone database or a dynamic web page address book. The telephone number database 22 stores therein telephone number data assigned to respective telephone users whereas the web page address database 24 stores therein the web page addresses corresponding to the respective telephone numbers. The network access controller 12 determines whether the transmitted information from the user's cellular phone as received by the transmitted information receiver 14 includes an input telephone number and/or an identification key input distinguished from the input telephone number. If the network access controller 12 determines that the transmitted information only includes the input telephone number, the controller 12 allows the user's cellular phone 1 to be wirelessly connected to the mobile telecommunication network 3 through the mobile telecommunication network accessing unit 16, thereby wirelessly connecting to the counterpart telephone 7.

If the network access controller 12 determines that the transmitted information from the user's cellular phone 1 includes both the input telephone number and the input identification key distinguished from the input telephone number, the controller 12 retrieves the web page address corresponding to the telephone number input by the user from among the telephone numbers and the web page address data corresponding to the respective telephone numbers stored in the database 20. If the web page address is retrieved, the network access controller 12 wirelessly accesses the web page server 9 through the wireless Internet accessing unit 18 and locates the web page corresponding to the retrieved web page address, to thereby allow the user's cellular phone 1 to be wirelessly connected to the concerned web page through the wireless Internet network 5.

As described above, the wireless Internet accessing system 10 accommodates retrieving web pages corresponding to input telephone numbers by allowing the user to access desired web pages of telephone number holders, if the user inputs both a telephone number and an identification key distinguished from the telephone number. Accordingly, even though the user does not know the URL address of the web page that the user desires to access, the user can automatically access the desired web page by entering the telephone number of the web page holder. The present invention implemented as a wireless Internet accessing system is a system and method of instantly determining/locating/accessing web pages of target telephone number holders in response to a single web page locator signal (key input or other input command techniques, such as voice, etc.). More particularly, the present invention provides a real-time and/or dynamic web page locator using a single input signal. Further, the present invention provides phone page numbers, which advantageously accommodate a dynamic web page address book by obviating web page address input by the user or web page address maintenance by the user (i.e., a dynamically updated web page address book), or accommodate a real-time and/or dynamic web page address locator.

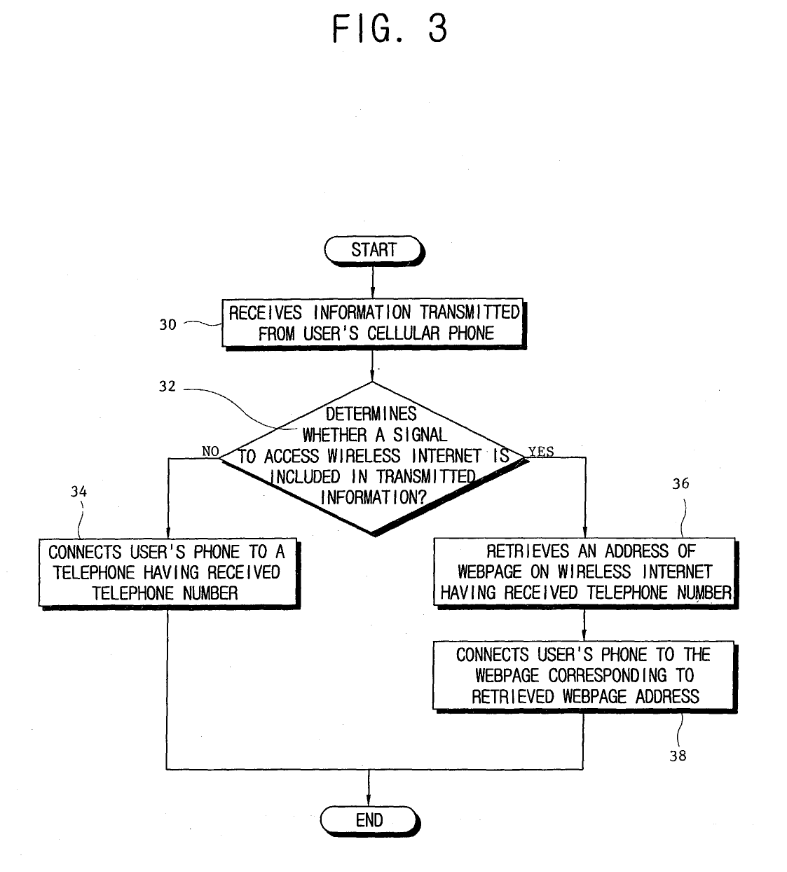

FIG. 3 is a flow chart of a wireless Internet accessing method using the wireless Internet accessing system 10 shown in FIG. 2 according to an embodiment of the present invention. Referring to FIG. 3, at operation 30, the wireless Internet accessing system 10 receives information transmitted (input) from the user's cellular phone 1 through the transmitted information receiver 14. At operation 32, network access controller 12 of the wireless Internet accessing system 10 determines whether the transmitted information from the user's cellular phone 1 as received includes an input telephone number and additionally an input identification key distinguished from an input telephone number.

If, at operation 32, it is determined that the identification key is not included or input, at operation 34, the network access controller 12 allows the user's cellular phone 1 and a telephone having the telephone number included in the transmitted information to be wirelessly connected with each other through the mobile telecommunication network 3, so that the user and the concerned telephone can make a conversation by phone. More particularly, at operation 32, the determination of a valid input telephone number and another distinguishing signal can be made using known techniques.

If, at operation 32, it is determined that the transmitted information from the user includes both the input telephone number and the input identification key distinguished from the input telephone number, at operation 36, the network access controller 12 retrieves a web page address corresponding to the input telephone number. If the web page is retrieved, at operation 38, the network access controller 12 allows the user's cellular phone 1 to be wirelessly connected to the desired web page having the retrieved web page address through the wireless Internet network 5.

As described above, the present invention enables a wireless Internet accessing system receiving input information from a user at a cellular phone to retrieve a web page corresponding to a telephone number input by the user, so as to allow the user to wirelessly access the web page of the telephone number holder as desired, if the user inputs a telephone number and an identification key distinguished from the input telephone number. Accordingly, the user can access the web page of another having the telephone number input by the user, merely by entering the telephone number of the other. Accordingly, the present invention provides a system and a method of accessing the wireless Internet by allowing a user to access web pages on the wireless Internet through a cellular phone and entering a telephone number in lieu of a URL into the cellular phone.

Although the above-described embodiments illustrate application of the present invention in a wireless telephone network, the present invention is not limited to such configuration, and the present invention can be used in wire or wireless communication networks to access Internet web pages by entering/knowing a telephone number, to provide web page phone numbers (web page numbers) and/or to provide a real-time and/or dynamic web page address finder. More particularly, the present invention provides a business model (and system thereof) of replacing an Internet web page address with a phone page number having characteristics of a telephone number to determine in real-time an Internet web page address of a web page holder by knowing a telephone number of the web page holder. As another business model, the present invention provides an Internet web page address directory based upon telephone number knowledge, thereby providing a web page or Internet assistant. Further, a web page address of a telephone number holder can be determined with a single input command (for example, by entering a single speed dial to transmit a telephone number and another distinguishing signal, etc.). Further, the present invention provides a phone page number comprising a telephone number and another signal. Further, the present invention provides a real-time and/or dynamic Internet web page address book or directory, having a benefit of being user maintenance free by relieving the user from updating the address book or the directory. Further, the present invention provides a target language web page address retriever (accessing device) by allowing determination/access of/to web page addresses in target languages other than a default language of a requesting/accessing device, such as a cellular phone, having a benefit of obviating user input in a target language. The processes of the present invention can be implemented using computing hardware and/or software.

Although embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A wireless Internet accessing system comprising:
a transmitted information receiver receiving information transmitted from a cellular phone;
a wireless Internet accessing unit wirelessly accessing an Internet;
a web page address database storing therein a plurality of telephone numbers and web page addresses corresponding to the respective telephone numbers; and
a network access controller determining whether the transmitted information received through the transmitted information receiver has both signals of a telephone number and an identification key distinguished from the telephone number signal, retrieving a web page address corresponding to the telephone number from the web page address database if determined that the identification key signal is additionally included, and controlling the cellular phone to be connected to a web page having the retrieved web page address, allowing the cellular phone to wirelessly access the Internet through the wireless Internet accessing unit.

2. The wireless Internet accessing system according to claim 1, further comprising a mobile telecommunication network accessing unit accessing a mobile telecommunication network;
wherein the network access controller controls the cellular phone to be connected to another telephone having the telephone number included in the transmitted information, allowing the cellular phone to be connected to the mobile telecommunication network through the mobile telecommunication network accessing unit.

3. A wireless Internet accessing method comprising:
receiving information transmitted by a cellular phone;
determining whether the received information comprises a telephone number signal and an identification key signal distinguished from the telephone number signal;
retrieving a web page address corresponding to the telephone number signal, if determined that the identification key signal is included in the received information; and
connecting the cellular phone to a web page corresponding to the web page address.

4. The wireless Internet accessing method according to claim 3, further comprising allowing the cellular phone to be connected to a telephone corresponding to the telephone number included in the received information, if determined that the received information does not include the identification key signal.

5. The method of claim 3, further comprising:
inputting a single command at the cellular telephone as the information transmitted by the cellular phone, thereby determining the web page address corresponding to the telephone number.

6. The method of claim 3, wherein the information transmitted by the cellular phone as a phone page number replaces the web page address to access in real-time the web page of a web page holder.

7. The method of claim 3, wherein the information transmitted by the cellular phone as a phone page number has characteristics of the telephone number to determine and/or access in real-time the web page of a web page holder.

8. The method of claim 3, wherein the retrieving of the web page address corresponding to the telephone number provides a dynamic Internet web page address book.

9. An Internet web page address retriever using a telephone network, comprising:
a transmitter transmitting a phone page number to an Internet accessing system via the telephone network; and
a receiver displaying a retrieved alphanumeric web page address of the phone page number according to signals received via the telephone network from the Internet accessing system.

10. The retriever of claim 9, further comprising a telephone key pad allowing input of the phone page.

11. An Internet accessing system comprising:
a receiver receiving a phone page number signal from a device;
a web page address database storing phone page numbers to access web page addresses; and
a programmed computer processor determining a web page address corresponding to the received phone page number signal and connecting the device to the determined web page address.

12. The system of claim 11, wherein the received phone page number signal comprises a telephone number signal and an identification key signal distinguished from the telephone number signal.

13. The system of claim 11, wherein the programmed computer processor transmits to the device the determined web page address.
